(19) United States
(12) Patent Application Publication
(10) Pub. No.: US 2022/0134473 A1
(43) Pub. Date: May 5, 2022

(54) METHOD FOR DETERMINING SPATTER CHARACTERISTICS IN LASER MACHINING AND ASSOCIATED MACHINING MACHINE AND COMPUTER PROGRAM PRODUCT

(71) Applicant: TRUMPF Laser- und Systemtechnik GmbH, Ditzingen (DE)

(72) Inventors: Johannes Seebach, Stuttgart (DE); Nicolai Speker, Pleidelsheim (DE); Steven Weidgang, Stuttgart (DE)

(21) Appl. No.: 17/578,700

(22) Filed: Jan. 19, 2022

Related U.S. Application Data
(63) Continuation of application No. PCT/EP2020/072147, filed on Aug. 6, 2020.

(30) Foreign Application Priority Data
Aug. 20, 2019 (DE) 10 2019 212 403.8

(51) Int. Cl. B23K 26/03; G06T 7/00; B23K 26/06; B23K 31/12

(52) U.S. Cl. CPC B23K 26/032; B23K 31/125; B23K 26/06; G06T 7/0004

(57) ABSTRACT

A method for determining at least one spatter characteristic of spatter particles which emanate from a melting zone of a workpiece during machining of the workpiece using a machining beam, in particular a laser beam, includes recording images of a spatial region through which spatter particles fly during the machining of the workpiece, and determining the at least one spatter characteristic by evaluating the recorded images. The spatter particles are respectively tracked over multiple images recorded one after the other in time and the at least one spatter characteristic is determined by using across-the-images evaluation of the multiple images. A machining machine and a non-transitory computer program product are also provided.

### CROSS-REFERENCE TO RELATED APPLICATION

This application is a continuation, under 35 U.S.C. § 120, of copending International Patent Application PCT/EP2020/072147, filed Aug. 6, 2020, which designated the United States; this application also claims the priority, under 35 U.S.C. § 119, of German Patent Application DE 10 2019 212 403.8, filed Aug. 20, 2019; the prior applications are herewith incorporated by reference in their entirety.

### FIELD AND BACKGROUND OF THE INVENTION

The present invention relates to a method for determining at least one spatter characteristic of spatter particles which, during the machining of a workpiece by using a machining beam, in particular a laser beam, emanate from a melting zone of the workpiece, with the following method steps:
recording images of a spatial region through which spatter particles fly during the machining of the workpiece, and
determining the at least one spatter characteristic by evaluating the recorded images.

The invention also relates to a machining machine suitable for carrying out this method, including a machining head for directing a machining beam, in particular a laser beam, onto a workpiece to be machined, a camera which is directed onto a spatial region through which spatter particles emanating from a melting zone of the workpiece fly during the machining of the workpiece, and an image processing unit for evaluating the spatter particles in an image recorded by the camera.

Such a method and such a device are disclosed for example in German Patent DE 10 2014 107 716 B3.

During the welding process by using a laser, a melt pool occurs at the place at which the laser beam impinges on the workpieces to be joined. In deep welding, very high power densities of approximately 1 megawatt per square centimeter are necessary. The laser beam then not only melts the metal, but also produces vapor. A deep, narrow vapor-filled hole known as the vapor capillary (also called a keyhole) then forms in the metal melt. The vapor capillary is the result of an equilibrium between the pressure of the evaporating material and the surface tension and gravitational force acting on the melt which counteract the vapor pressure to close the vapor capillary. The vapor capillary is therefore surrounded by liquid metal. That liquid region is generally referred to as the melt pool. The shape of the melt pool (width, length) is characterized by the speed of relative movement between the laser beam and the material, the form of the heat source and to a great extent by the component itself. Welds that proceed homogeneously generally lead to the formation of a uniform melt pool, i.e. the melt pool is of a constant size during the process. Changes as the weld proceeds (gap, speed, heat dissipation) have the effect however of causing changes in the size of the melt pool. That can have the consequence that the natural oscillations at determinate points on the surface of the melt pool, dependent on the size of the melt pool, become overlaid and form so-called “melt waves.” Those may move through the melt pool in all directions. Accordingly, the melt waves form a further factor which can disturb the described equilibrium that maintains the vapor capillary. The continual pumping of the vapor capillary has the effect that the vapor flowing out continually entrains minute amounts of the melt in the form of process emissions. If that process is disturbed by “melt waves,” the vapor capillary breaks down. Trapped gas and the simultaneous creation of a new vapor capillary lead to spatter particles of molten material, which are deposited near the weld on the surface of the workpieces. The ejected material is missing from the weld, which in the worst case necessitates reworking. In addition, the deposited spatter particles of metal have to be removed, which necessitates costly reworking.

German Patent DE 10 2014 107 716 B3, cited at the beginning, discloses a method for reducing welding spatter during welding with a laser beam, the laser beam performing a spatially oscillating movement overlaid on the feed movement parallel or perpendicular to the joint during the welding. The oscillation parameters of that oscillation are dynamically adapted during the welding process in such a way that the occurrence of welding spatter is reduced. As a basis for the adaptation of the oscillation parameters, the number and size of the welding spatter particles recorded in an image segment of images recorded at a high repetition rate with a camera from the laser focal point and the joint are evaluated in real time. However, the same spatter particles are possibly detected multiple times in multiple images, which leads to a falsification of the recorded number of welding spatter particles.

### SUMMARY OF THE INVENTION

It is accordingly an object of the invention to provide a method for determining spatter characteristics in laser machining, an associated machining machine and a computer program product, which overcome the hereinafore-mentioned disadvantages of the heretofore-known methods, machines and computer program products of this general type and in which spatter characteristics, such as for example the number of spatter particles, can be determined as unfalsified as possible and also dynamic spatter characteristics, such as for example the production rate, speed and trajectory of the spatter particles, can be determined.

With the foregoing and other objects in view there is provided, in accordance with the invention, a method, a machine and a computer program product in which the spatter particles are respectively tracked over multiple images recorded one after the other in time and the at least one spatter characteristic is determined by across-the-images evaluation of the multiple images.

According to the invention, the images are evaluated across the images with regard to spatter characteristics relevant to machining quality. The spatter characteristics may be the number and size of the spatter particles, but also the production rate, production density, speed and trajectory of the spatter particles. A loss in material volume of the melting zone caused by the spatter particles and, with knowledge of the particle density, also the associated loss in mass of the melting zone, can be ascertained from the determined number and size of the spatter particles. The machining laser beam is a thermal machining beam, such as for example a laser beam or an electron beam.

The evaluated images are preferably individual images of a recorded video sequence, whereby a clear across-the-images assignment of the individual spatter particles in the individual images is ensured.

When counting the spatter particles, one and the same spatter particle is advantageously only counted in one of the multiple images, in particular only when it occurs for the first time in an image, by using the across-the-images evaluation. This measure has the effect of preventing the same spatter particles from being counted multiple times in multiple images, which would lead to a falsification of the determined number of spatter particles.

Particularly preferably, when it occurs for the first time in an image, a spatter particle is assigned its own identifier, with which the spatter particle is also identified in the subsequent images. The across-the-images evaluation then evaluates a spatter particle identified in the images by the same identifier with regard to characteristics relevant to machining quality.

Particularly preferably, at least one machining parameter is set or altered during the machining of the workpiece on the basis of the at least one spatter characteristic determined, to be precise advantageously in the direction of a reduction in the number and/or size of the spatter particles. When machining the workpiece by using a laser beam, the at least one machining parameter preferably includes at least one of the following laser welding parameters: the total power of the laser beam, the pulse frequency of the laser beam, the laser power modulation of the laser beam, the focal position of the laser beam and the division of the laser power between a core fiber and a ring fiber of a dual fiber in which the laser beam is guided in the direction of the workpiece. When using a dual fiber with a core fiber and a ring fiber, the quality of the weld is influenced by various process parameters. One of the main factors is the division of the laser power between the core fiber and the ring fiber (2in1 fiber), which must be adapted to satisfy the requirements of the welding process. In order to obtain information concerning the stability of the process or the occurrence of welding spatter parallel to the welding operation, the forming of spatter in the process or melting zone is recorded by using a suitable process camera. Depending on the number and size of the spatter particles occurring, the power distribution of the dual fiber, that is to say the laser power distribution between the core fiber and the ring fiber, is adapted or controlled. The controlling of further parameters relevant to the process, such as the laser pulse frequency and the laser power modulation, is also conceivable.

Preferably, the quality of the machining of the workpiece is ascertained on the basis of the at least one spatter characteristic determined. Thus, for example, the total number of spatter particles determined during the machining of the workpiece may be used as a criterion for quality assurance.

With the objects of the invention in view, there is also provided a machining machine, including a machining head for directing a machining beam, in particular a laser beam, onto a workpiece to be machined, a camera, which is directed onto a spatial region through which spatter particles emanating from a melting zone of the workpiece fly during the machining of the workpiece, and an image processing unit for evaluating the spatter particles in an image recorded by the camera, the image processing device having according to the invention an across-the-images evaluation device, which respectively tracks the spatter particles over multiple images recorded one after the other in time and determines at least one spatter characteristic from the multiple images. The across-the-images evaluation device allows in particular the quantification and qualification of the spatter particles. A CMOS camera with sufficiently good temporal and spatial resolution may be used for example as the camera. With the machining machine according to the invention, the same advantages are obtained as in the case of the method according to the invention.

Preferably, the machining machine has a control unit, which is programmed to set or alter during the machining of the workpiece at least one machining parameter on the basis of the at least one spatter characteristic determined.

In order to cover the spatial region through which the spatter particles fly, the camera may be aligned parallel or coaxial to the machining beam impinging on the workpiece or at an angle to the workpiece surface, in particular to the melting zone, or parallel to the workpiece surface.

Particularly advantageously, the camera is constructed as a video camera. On the basis of a recorded video sequence, a spatter particle in the individual images can be tracked or identified particularly easily and simply across the images.

With the objects of the invention in view, there is concomitantly provided a computer program product, which has code adapted for carrying out all of the steps of the method according to the invention when the program runs on a controller of a machining machine.

Further advantages and advantageous refinements of the subject matter of the invention can be taken from the description, the drawing and the claims. Similarly, the features mentioned above and features still to be set out can each be used on their own or together in any desired combinations. The embodiments shown and described should not be understood as an exhaustive list, but rather as being of an exemplary character for the description of the invention.

Other features which are considered as characteristic for the invention are set forth in the appended claims.

Although the invention is illustrated and described herein as embodied in a method for determining spatter characteristics in laser machining and an associated machining machine and a computer program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic and block diagram of a machining machine according to the invention for the laser beam welding of workpieces; and

FIGS. 2A-2C are plan views showing images recorded one after the other in time of welding spatter particles produced during the laser beam welding.

### DETAILED DESCRIPTION OF THE INVENTION

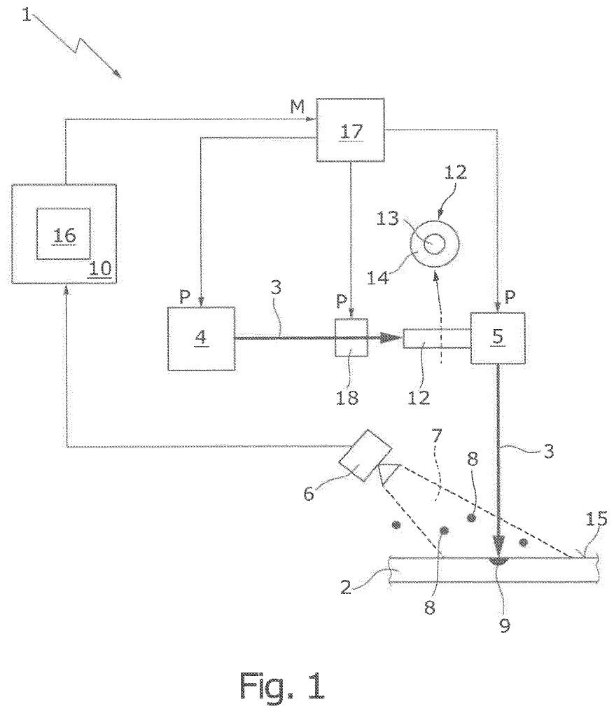

Referring now to the figures of the drawings in detail and first, particularly, to FIG. 1 thereof, there is seen a machining machine 1 which serves for welding a workpiece 2 by using a laser beam 3.

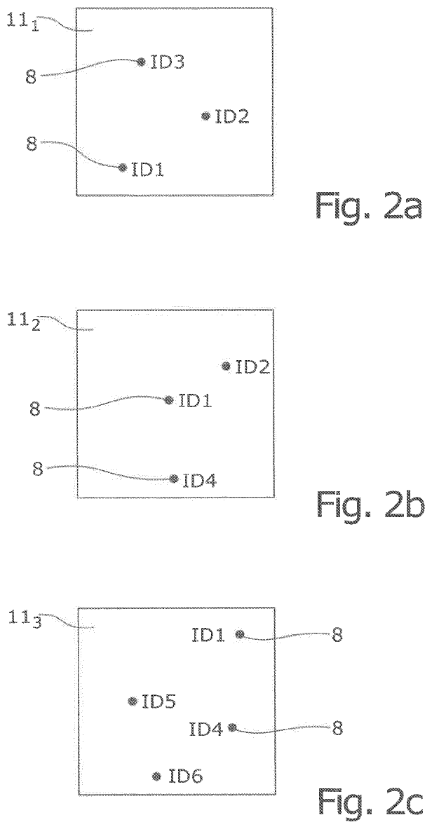

The machining machine 1 includes a laser beam generator 4 for generating the laser beam 3, a machining head 5 for directing the laser beam 3 onto the workpiece 2, a camera 6, which is directed onto a spatial region 7 through which spatter particles 8 emanating from a melting zone 9, which is melted by the laser beam 3, of the workpiece 2 fly during the machining of the workpiece, and an image processing unit 10 for evaluating the spatter particles 8 in an image 11₁-11₃ recorded by the camera 6 (FIGS. 2A-2C). As shown in FIG. 1, the laser beam 3 is guided in the direction of the workpiece 2 in a dual fiber 12, which has a core fiber 13 and a ring fiber 14, surrounding the core fiber 13.

Unlike in the exemplary embodiment shown, in which the camera 6 is directed onto the melting zone 9 at an angle to the workpiece surface 15, the camera 6 may alternatively also be aligned parallel or coaxial to the laser beam 3 impinging on the workpiece 2 or else parallel to the workpiece surface 12. The camera 6 may be configured for recording individual images or else as a video camera for recording a video sequence.

The image processing device 10 has an across-the-images evaluation device 16, which can respectively track the spatter particles 8 over multiple images 11₁-11₃ recorded one after the other in time and determine one or more spatter characteristics M from the multiple images 11₁-11₃.

The machining machine 1 also has a control unit 17, which is programmed to set during the machining of the workpiece at least one welding parameter P on the basis of the determined spatter characteristic M. There is disposed in the beam path of the laser beam 3 a deflecting unit 18, which is activated by the control unit 17 and, in accordance with the determined spatter characteristic M, deflects the laser beam 3 either only into the core fiber 13 or only into the ring fiber 14 or both into the core fiber 13 and into the ring fiber 14.

In laser beam welding with a dual fiber 12, the quality of the weld is influenced by various machining or process parameters. One of the main machining parameters is the division of the welding power between the core fiber 13 and the ring fiber 14, which must be adapted to satisfy the requirements of the welding process in order to minimize as far as possible the number and size of the spatter particles 8. In order to obtain information concerning the stability of the process or the occurrence of spatter particles 8 parallel to the welding operation, the forming of spatter in the melting zone 9 is recorded by using the camera 6. For this purpose, images 11₁-11₃ of the spatial region 7 are recorded during the machining of the workpiece and can then be used by the image processing unit 10 to determine the number and size of the occurring spatter particles 8. In order in this case not to count the same spatter particle 8 multiple times in the individual images 11₁-11₃, the spatter particles 8 are respectively tracked by the across-the-images evaluation device 16 over multiple images 11₁-11₃ recorded one after the other in time and the number and size of the spatter particles 8 are determined by the across-the-images evaluation device 16 from the multiple images 11₁-11₃.

As shown in FIGS. 2A-2C, when it occurs for the first time in an image 11₁-11₃, a spatter particle 8 is assigned its own identifier ID1-ID6, with which this spatter particle 8 is then also identified in the subsequent images 11₁-11₃. The division of the welding power between the core fiber 13 and the ring fiber 14 is adapted or controlled depending on the number and size of the spatter particles 8 thus determined. To be more specific, during the machining of the workpiece, the control unit 17 determines from the determined number and size of the spatter particles 8 as a machining parameter P a power dividing parameter, which is passed on as a manipulated variable to the deflecting unit 18, which then deflects the laser beam 3 correspondingly. A loss in material volume of the melting zone 9 caused by the spatter particles 8 and, with knowledge of the particle density, also the associated loss in mass of the melting zone 9, can be ascertained from the determined number and size of the spatter particles 8.

As an alternative or in addition to the number and size of the spatter particles 8, other spatter characteristics M may also be determined from the multiple images 11₁-11₃, such as for example the production rate and density of the spatter particles 8, the speed of the spatter particles 8 or else the trajectory of the spatter particles 8.

As indicated in FIG. 1, during the machining of the workpiece, the control unit 17 may use the spatter characteristic or characteristics M for also adapting or controlling other machining parameters P, such as for example the total power, the pulse frequency or the focal position of the laser beam 3, and pass them on as manipulated variables to the corresponding components, for example to the laser beam generator 4 or the machining head 5.

The determined spatter characteristic or characteristics M may also be used as a criterion for the quality of the machining of the workpiece 2.

1. A method for determining at least one spatter characteristic of spatter particles emanating from a melting zone of a workpiece during machining of the workpiece using a machining beam or laser beam, the method comprising:
recording images of a spatial region through which spatter particles fly during the machining of the workpiece by tracking the spatter particles respectively over multiple images recorded one after another in time; and
determining the at least one spatter characteristic by evaluating the recorded images by using across-the-images evaluation of the multiple images.

2. The method according to claim 1, which further comprises providing the images as individual images of a recorded video sequence.

3. The method according to claim 1, which further comprises determining the at least one spatter characteristic as follows by using the across-the-images evaluation:
a number of spatter particles, or
a size of the spatter particles, or
a production rate of the spatter particles, or
a production density of the spatter particles, or
a speed of the spatter particles, or
a trajectory of the spatter particles.

4. The method according to claim 3, which further comprises ascertaining a loss in material volume of the melting zone, caused by the spatter particles, from the determined number and size of the spatter particles.

5. The method according to claim 1, which further comprises counting each respective spatter particle in only one of the multiple images or only when the respective spatter particle occurs for a first time in an image, by using the across-the-images evaluation.

6. The method according to claim 1, which further comprises assigning a spatter particle its own identifier upon the spatter particle occurring for a first time in an image, and using the identifier to also identify the spatter particle in subsequent images.

7. The method according to claim 1, which further comprises setting or altering at least one machining parameter during the machining of the workpiece based on the at least one determined spatter characteristic.

8. The method according to claim 7, which further comprises setting or altering the at least one machining parameter in a direction of a reduction in at least one of a number or size of the spatter particles.

9. The method according to claim 7, which further comprises including at least one laser welding parameter as follows in the at least one machining parameter when machining the workpiece by using the laser beam:
a total power of the laser beam, or
a pulse frequency of the laser beam, or
a laser power modulation of the laser beam, or
a focal position of the laser beam and a division of the laser power between a core fiber and a ring fiber, surrounding the core fiber, of a dual fiber in which the laser beam is guided in a direction of the workpiece.

10. The method according to claim 1, which further comprises ascertaining a quality of the machining of the workpiece based on the at least one determined spatter characteristic.

11. A machining machine, comprising:
a machining head for directing a machining beam or a laser beam onto a workpiece to be machined;
a camera directed onto a spatial region through which spatter particles emanating from a melting zone of the workpiece fly during the machining of the workpiece; and
an image processing unit for evaluating the spatter particles in an image recorded by said camera, said image processing device having an across-the-images evaluation device respectively tracking the spatter particles over multiple images recorded one after another in time and determining at least one spatter characteristic from the multiple images.

12. The machining machine according to claim 11, which further comprises a control unit programmed to set or alter at least one machining parameter during the machining of the workpiece based on the at least one determined spatter characteristic.

13. The machining machine according to claim 12, which further comprises:
a dual fiber guiding the laser beam in a direction of the workpiece, said dual fiber including a core fiber and a ring fiber surrounding said core fiber; and
a deflecting unit disposed in a beam path of the laser beam, said deflecting unit being activated by said control unit and, in accordance with the at least one determined spatter characteristic, deflecting the laser beam either only into said core fiber or only into said ring fiber or both into said core fiber and into said ring fiber.

14. The machining machine according to claim 11, wherein said camera is aligned parallel or coaxial to the machining beam impinging on the workpiece or at an angle to a surface of the workpiece or parallel to the surface of the workpiece.

15. The machining machine according to claim 11, wherein said camera is a video camera.

16. A non-transitory computer program product with instructions stored thereon that when executed on a controller of a machining machine performs the steps of claim 1.
